(19) United States
(12) Patent Application Publication
(10) Pub. No.: US 2006/0064851 A1
(43) Pub. Date: Mar. 30, 2006

(54) Method and apparatus for a handle

(76) Inventor: Kelly L. Kincaid, San Jose, CA (US)

Correspondence Address: HEIMLICH LAW, 5952 DIAL WAY, SAN JOSE, CA, 95129, US

(21) Appl. No.: 11/238,353

(22) Filed: Sep. 28, 2005

Related U.S. Application Data
(60) Provisional application No. 60/614,265, filed on Sep. 29, 2004.

(51) Int. Cl. A47J 45/10

(52) U.S. Cl. 16/435

(57) ABSTRACT

A method and apparatus for a handle have been disclosed.

### RELATED APPLICATION

This patent application claims priority of U.S. Provisional Application Ser. No. 60/614,265 filed Sep. 29, 2004 titled “Method and Apparatus for a Handle”, which is hereby incorporated herein by reference.

### FIELD OF THE INVENTION

The present invention pertains to a handle. More particularly, the present invention relates to a method and apparatus for a handle for carrying items.

### BACKGROUND OF THE INVENTION

Shopping bags, grocery bags, tied boxes, etc. are used extensively and on a daily basis.

Often a heavily loaded bag has a small or thin handle, such as a plastic bag, which to carry any distance is painful due to the large pressures exerted on a hand. Additionally, it is often hard to grasp several bags' handles to keep them all together.

Many inventors have addressed this issue with varying degrees of success. However, none has provided a low cost easily manufactured product which is comfortable and durable. This presents a problem.

### BRIEF DESCRIPTION OF THE DRAWINGS

The invention is illustrated by way of example and not limitation in the figures of the accompanying drawings in which:

FIG. 1 illustrates one embodiment of the invention showing representative dimensions;

FIG. 2 is an illustration of one embodiment of the invention showing a perspective view;

FIG. 3 is an illustration of one embodiment of the invention showing a perspective view;

FIG. 4 is an illustration of various embodiments of the invention showing a top view;

FIG. 5 is an illustration of various embodiments of the invention showing a side view;

FIG. 6 is an illustration of one embodiment of the invention showing an end view in detail;

FIG. 7 is an illustration of another embodiment of the invention showing an end view in detail;

FIG. 8 illustrates one embodiment of the invention showing a typical usage; and

FIG. 9 illustrates one embodiment of the invention showing details of a Neoprene tube and a plastic skeleton.

### DETAILED DESCRIPTION

The invention, as exemplified in various embodiments, illustrates a method and apparatus for a handle.

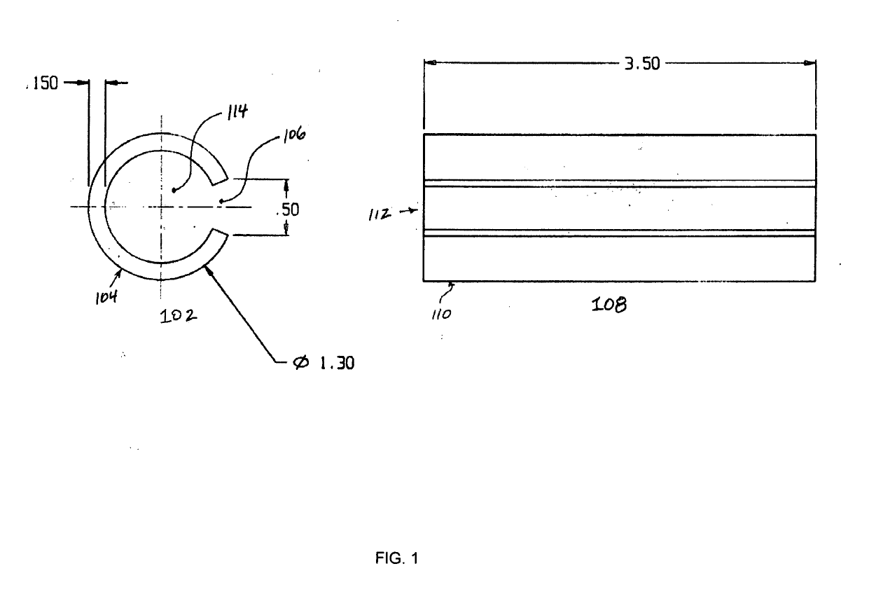

FIG. 1 illustrates one embodiment of the invention showing representative dimensions. At 102 is an end view of a substantially cylindrical tube 104 having an opening at 106. At 108 is a top view showing the substantially cylindrical tube 110 and the slot opening 112 extending the length of the substantially cylindrical tube 110. In use cords, bails, twine, or handles affixed to items to be carried may be inserted via opening 106 into the substantially cylindrical tube 104 inner opening 114.

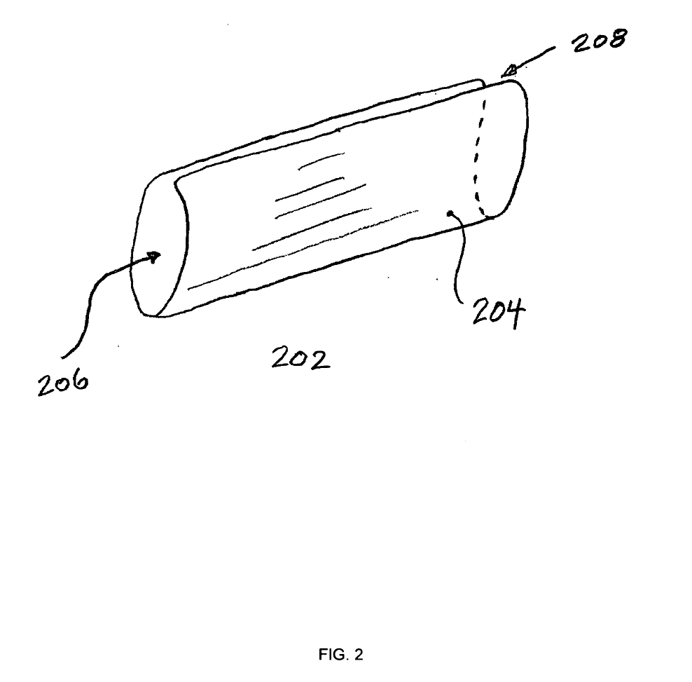

FIG. 2 is an illustration of one embodiment 202 of the invention showing a perspective view. Here at 204 is an outer surface having a gap at 208 where handles from bags may be placed into the void 206. In this embodiment of the invention the handle is oval in shape.

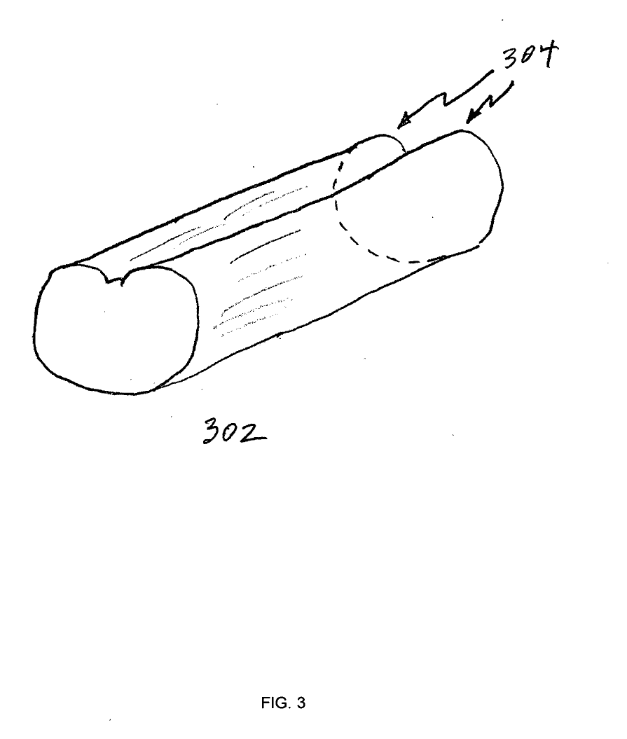

FIG. 3 is an illustration of one embodiment of the invention showing a perspective view. Here the handle 302 has curved upper surfaces 304 to assist with insertion of bag handles and the retention of such.

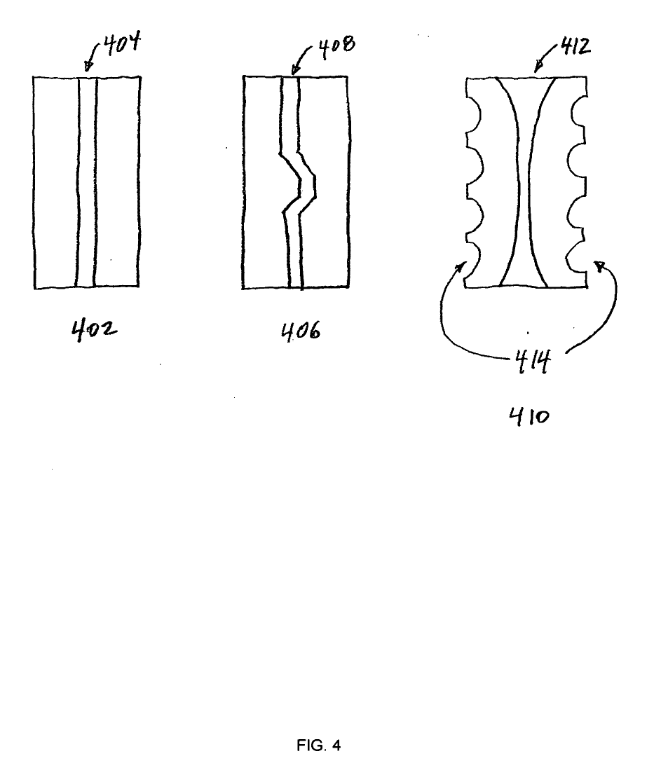

FIG. 4 is an illustration of various embodiments of the invention showing a top view. Here at embodiment 402 the slot 404 is substantially straight. At embodiment 406, the slot 408 has a “jog” near the middle of the handle. This jog assists in the retention of bag handles. The jog may be of varying dimensions and shapes and need not have straight edges as illustrated. At embodiment 410, the slot 412 is curved and the sides of the handle 414 are notched or indented. These indentions allow the fingers of a hand to more easily grasp the handle while distributing pressure more evenly.

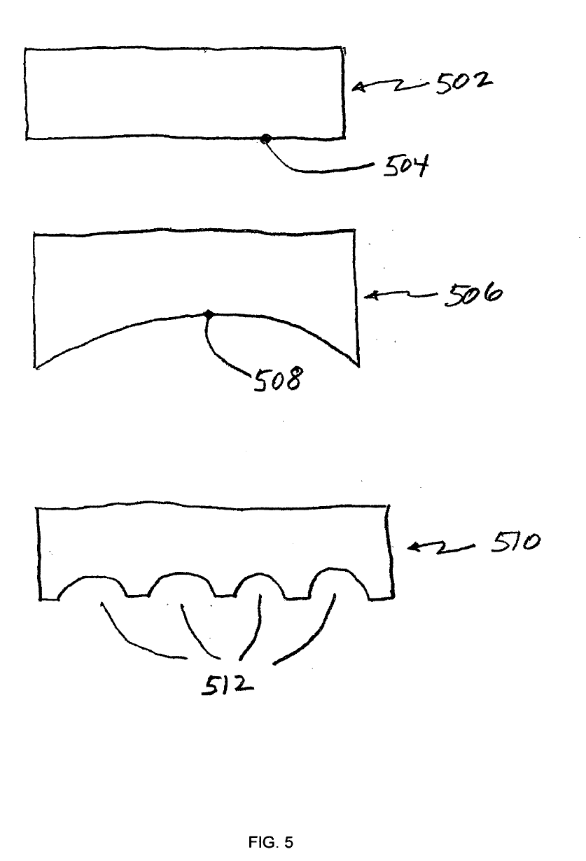

FIG. 5 is an illustration of various embodiments of the invention showing a side view. At 502 is one embodiment of the invention having a substantially flat surface 504 which can be grasped with a hand. At 506 is one embodiment of the invention having a curved hand surface 508. At 510 is one embodiment of the invention having a series of dimples or indentions 512 where fingers of a hand may be placed.

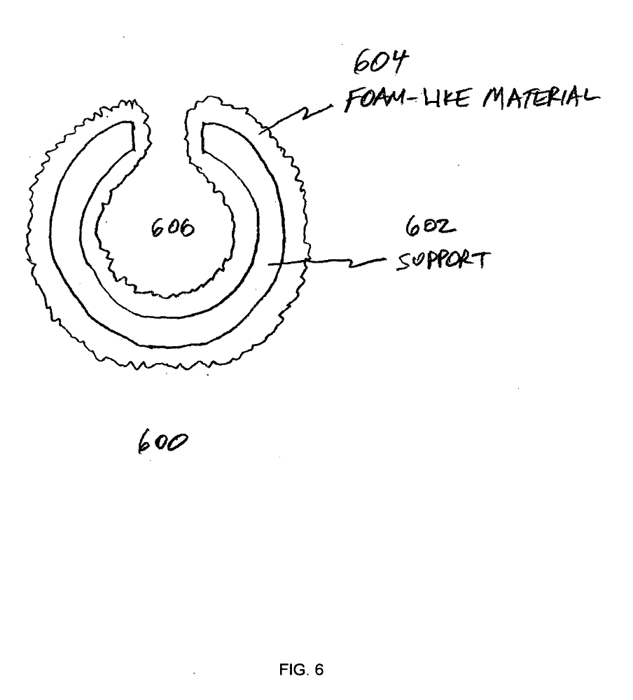

FIG. 6 is an illustration of one embodiment of the invention showing an end view in detail. The embodiment 600 shows in greater detail the construction of some of the embodiments of the invention. Here at 602 is a substantially rigid support. For example, 602 may be constructed of metal, PVC, plastic, etc. 602 is of a material that is not substantially deformed under the weigh of the bags, etc. carried using the handle. At 604 is a foam-like material which is resilient. For example, 604 may be constructed of RTV, foamed plastics, Neoprene, etc. 604 is of a material that has resiliency so that it may conform to a hand under the weigh exerted by bags being carried using the handle yet return to its original shape when no pressure is applied to it.

When a handle such as that at FIG. 6 is in use, the resilient material at 604 provides several functions. As mentioned, it provides a more comfortable support for a hand. Also, bag handles placed within the interior 606 when resting against the resilient material 604 tend not to slide or slip because of the deformation of the resilient material 604. Additionally, the resilient material 604 will flex based upon the user walking and will thus tend to cushion the load on the hand.

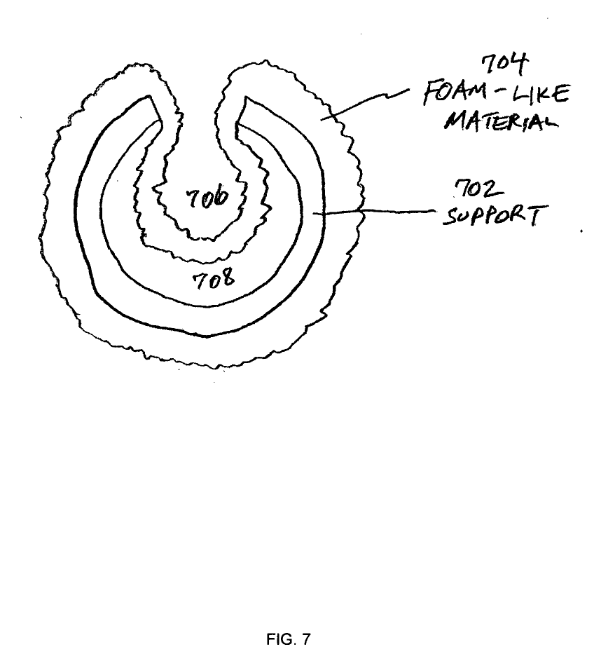

FIG. 7 is an illustration of another embodiment of the invention showing an end view in detail. The embodiment 700 shows in greater detail the construction of some of the embodiments of the invention. Here at 702 is a substantially rigid support. For example, 602 may be constructed of wood, metal, PVC, plastic, etc. 702 is constructed of a material that is not easily deformed under the weigh being carried when using the handle. At 704 is a foam-like cushioning material which is resilient. For example, 704 may be constructed of silicone, foamed plastics, Neoprene, etc. 704 is a material that has resiliency so that it may conform to a hand under the weigh exerted by bags being carried using the handle yet return to its original shape when no pressure is applied to it. It may also stretch under weight and return to its original length in the absence of weight.

When a handle such as that at FIG. 7 is in use, the resilient material at 704 provides several functions. As mentioned, it provides a more comfortable support for a hand. Also, bag handles placed within the interior 706 when resting against the resilient material 704 tend not to slide or slip because of the deformation of the resilient material 704. Additionally, since the resilient material 704 is not in direct contact with the support 702 everywhere, that is there is a gap at 708, the resilient material 704 will flex based upon the user walking and will thus tend to cushion the load on the hand.

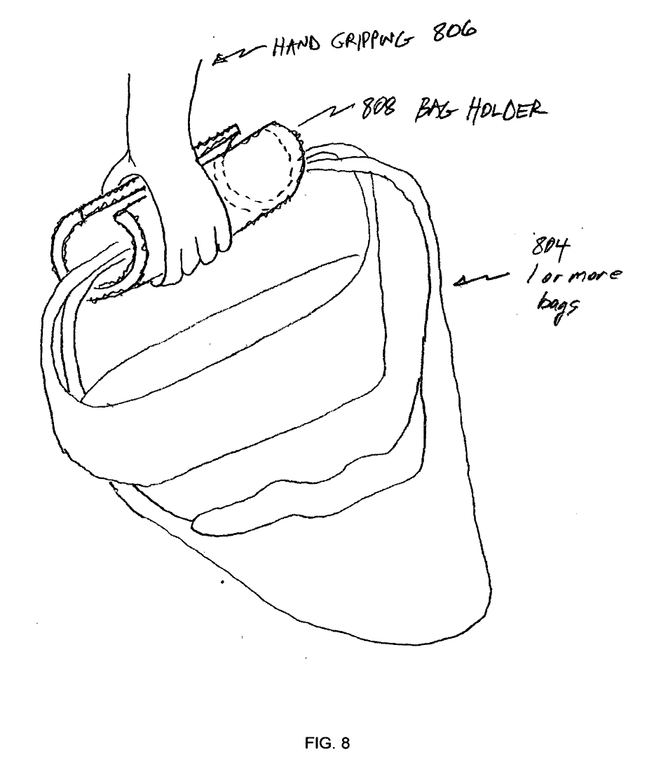

FIG. 8 illustrates one embodiment of the invention showing a typical usage. The bag holder 808 is held by a user gripping 806 the bag holder 808 which has several bags 804 whose handles are looped through the bag holder 808.

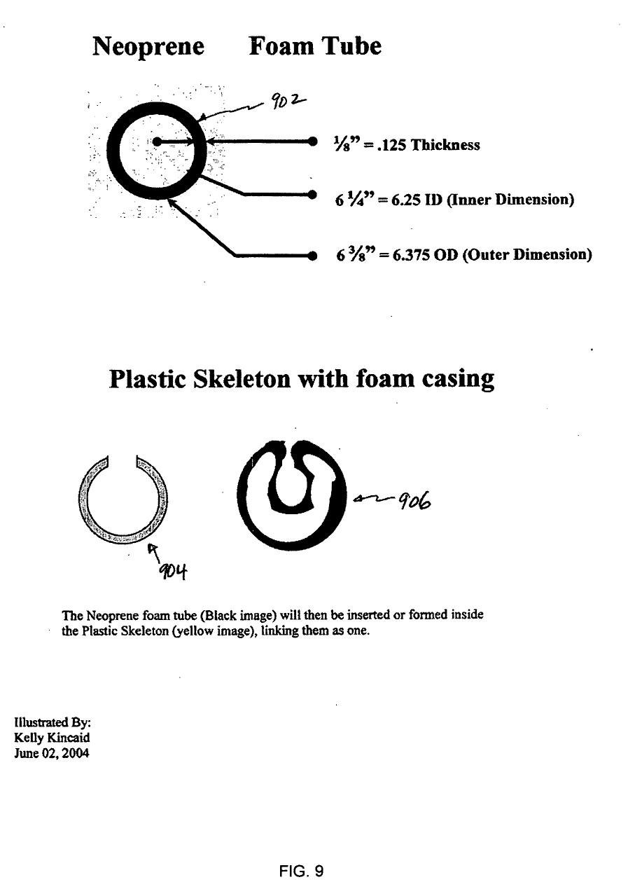

FIG. 9 illustrates one embodiment of the invention showing details of a Neoprene tube and a plastic skeleton. At 902 is a representative Neoprene tub showing dimensions. At 904 is a plastic skeleton. At 906, the Neoprene tube has been slid over the skeleton 904, and some of the tubing has been pushed into the interior of the skeleton 904 via the slot in the skeleton 904 to form the shape as shown at 906. This is similar to the end view illustrated in FIG. 7.

Depending upon the dimensions of the skeleton 904 and the dimensions of the Neoprene foam tube 902, one of skill in the art will appreciate that the dimensions of a void such as 708 in FIG. 7 may be controlled. Given the proper dimensions, the void 708 as in FIG. 7 may be eliminated and the Neoprene foam tube may rest fully substantially in contact with the skeleton 904 as illustrated in FIG. 6.

One of skill in the art will also appreciate that the easy assembly of sliding the tube over the skeleton and pushing part of it into the interior of the skeleton via the slot, also allows for easy removal for such things a changing the tubing, washing, etc. Nor is the invention limited to construction using this approach. For example, the tubing may be deformed and then the skeleton inserted end-wise into it.

The present invention may be also be fabricated by molding plastics of different densities, varying densities, bonding materials together, etc. For example, the tubing and foam may be ultrasonically bonded to each other. The tubing may have indicia or logos for advertising purposes, etc.

Thus a method and apparatus for a handle have been described.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of skill in the art that the present invention may be practiced without these specific details. In some instances, well-known structures and devices are shown in block diagram form, rather than in detail, in order to avoid obscuring the present invention. These embodiments are described in sufficient detail to enable those of skill in the art to practice the invention, and it is to be understood that other embodiments may be utilized and that logical, mechanical, electrical, and other changes may be made without departing from the scope of the present invention.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

Thus a method and apparatus for a handle have been described.

What is claimed is:

1. A handle comprising:
a tubular member having an outer surface, an inner surface, and a longitudinal length; and
a slot extending from said outer surface to said inner surface and of said longitudinal length.

2. The handle of claim 1 wherein said tubular member has a cross section selected from the group consisting of a circular section, an elliptical section, an oval section, a heart-shaped section, and a section shaped to fit a human hand.

3. The handle of claim 2 wherein said heart-shaped section has an opening at a top of said heart-shaped section and inwardly sloping portions.

4. The handle of claim 1 wherein said slot is of uniform width and extends straight along said longitudinal length.

5. The handle of claim 1 wherein said slot is of uniform width and jogs from a straight along said longitudinal length.

6. The handle of claim 1 wherein said slot is of expanding width from a middle of said tubular member to ends of said tubular member.

7. The handle of claim 6 wherein said outer surface of said tubular member is notched to accept fingers of a hand.

8. The handle of claim 1 wherein said outer surface of said tubular member has a shape selected from the group consisting of a straight shape, a convex shape, a concave shape, a dimpled surface, and a notched surface.

9. The handle of claim 1 further comprising:
a resilient material in communication with said outer surface of said tubular member;
a resilient material in communication with said inner surface of said tubular member; and
a resilient material in communication with said slot extending from said outer surface to said inner surface.

10. The handle of claim 1 further comprising:
a resilient material in communication with said outer surface of said tubular member;
a resilient material when at rest not in communication with said inner surface of said tubular member; and
a resilient material in communication with said slot extending from said outer surface to said inner surface.

11. The handle of claim 9 wherein said tubular member is a plastic-like material and said resilient material is a neoprene-like material.

12. The handle of claim 11 wherein said neoprene-like material is of a larger circumference than said tubular section and is fitted on the outer surface of said tubular member and excess said neoprene-like material is pressed into said slot and forms a U shaped section inside said tubular member.

13. The handle of claim 12 wherein said neoprene-like material is not fixedly attached to said tubular member.

14. The handle of claim 13 wherein said neoprene-like material may be removed, washed, and re-attached to said tubular member.

15. A method comprising:
forming a slot along a length of a hollowed member; and
covering an outer surface of said hollowed member with a resilient material.

16. The method of claim 15 further comprising:
covering an inner surface of said hollowed member with said resilient material.

17. The method of claim 15 further comprising:
forming said hollowed member with grooves positioned to accept gripping fingers.

18. The method of claim 15 further comprising:
forming said resilient material to fit gripping fingers.

19. A handle comprising:
an inner support having an inner surface an outer surface a first end and a second end and a slot extending from said first end to said second end, said slot allowing one or more string-like objects to be passed through said slot and approaching said inner surface; and
a padding material in communication with said outer surface and capable of being in communication with gripping fingers.

20. The handle of claim 20 wherein said slot is straight from said first end, jogs in the middle, and is straight to said second end.
